(19) United States
(12) Patent Application Publication
(10) Pub. No.: US 2016/0366990 A1
(43) Pub. Date: Dec. 22, 2016

(54) ARTICLE OF CLOTHING FOR ATTACHING COMMUNICATION EQUIPMENT THERETO

(71) Applicant: Rodney Smith, Mobile, AL (US)

(72) Inventor: Rodney Smith, Mobile, AL (US)

(21) Appl. No.: 14/742,130

(22) Filed: Jun. 17, 2015

(51) Int. Cl. A44B 17/00; H04R 1/02; A41D 13/02; H04R 1/08; A41B 1/08; A41D 3/00

(52) U.S. Cl. CPC A44B 17/0041; A41B 1/08; A41D 3/00; A41D 13/02; H04R 1/08; H04R 1/028

(57) ABSTRACT

A snap fastener system for securely attaching a piece of communication equipment, such as a two-way radio speaker microphone, to an article of clothing is provided. The system includes at least one strap attached to the article of clothing at each end of the strap. One half of a snap fastener is attached to the strap, and the corresponding half is attached to the speaker microphone. The speaker microphone can be quickly and easily attached to the article of clothing simply be snapping the two halves of the fastener together. Similarly, the microphone can be easily detached from the clothing by unsnapping the fastener. Additionally, a clip on the back of the microphone can be used to clip the microphone to the strap. Thus, there are two separate ways of attaching the microphone to the clothing to ensure that the microphone can be safely secured to the clothing at all times.

### FIELD OF THE INVENTION

A preferred embodiment of the invention is directed to an article of clothing adapted for securely attaching communication equipment to said article.

### BACKGROUND

Many types of occupations require workers to be in constant communication with each other in order to accomplish various tasks. For instance, law enforcement personnel, fire fighters, paramedics, operators working in refineries or chemical plants, workers on oil platforms or at other drilling sites, workers at various types of construction sites, crane operators, and crew members on boats, among other examples, must be able to instantaneously communicate with each other at all times. Typically, these types of workers use a hand-held two-way radio, such as a VHF or UHF radio, or similar communication equipment. A two-way radio allows multiple individuals to both transmit and receive communications with anyone using a radio operating on the same radio frequency, or channel.

Hand-held two-way radios typically comprise a handset having a push-to-talk button, an antenna, and a clip on the back of the radio. Often, hand-held radios also comprise a separate speaker microphone. The speaker microphone is typically connected to the handset by a coiled cord, which allows the user to operate the radio more easily. The speaker microphone typically comprises a separate push-to-talk button and a clip on the back of the speaker microphone. When using a radio having a speaker microphone, the user generally clips the handset to his belt or otherwise attaches the handset to his person in the waist area. The speaker microphone is then typically clipped to a shirt pocket, a shirt collar, or to a button-down shirt along the edge of material where the shirt opening is buttoned together. This allows the user to easily access the speaker microphone to hold it to his mouth for transmitting a message or to his ear for receiving a message.

A common problem with hand-held radios is that the clips on the speaker microphone sometimes break, rendering the clips non-functional. The clips are typically made of plastic and are spring operated. The clip can break either by the plastic cracking or by the spring failing due to normal wear and tear. When this happens, there is no way to secure the speaker microphone, and replacement microphones are not always readily available. In this case, a common practice is for the user to loop the speaker microphone cord over his shoulder because his hands must be available for other tasks and there is no other way of securing the microphone to his person. However, while the user is doing other work the speaker microphone may fall off his shoulder if it is simply looped over his shoulder and not secured. Because the cords are typically coiled, the speaker microphone may fall to a location several feet from the user, which may create a dangerous situation. In certain work environments, workers must be able to communicate instantly in order to prevent accidents or other unsafe work conditions. A delay in communication while a user is trying to get his speaker microphone back can potentially lead to accidents. An unsecured speaker microphone may also create a tripping hazard, or it may distract a worker from a critical job while he is trying to secure a microphone that has fallen. Thus, it is advantageous for the speaker microphone to be secure at all times.

Accordingly, a need exists in the art for an article of clothing adapted for securely attaching communication equipment, such as a speaker microphone, to said article. Furthermore, a need exists in the art for a simple and easy to use fastening system for securely attaching a piece of communication equipment to an article of clothing.

### SUMMARY

In accordance with the present invention, a snap fastener system for securely attaching a piece of communication equipment, such as a two-way radio speaker microphone, to an article of clothing is provided. Furthermore, an article of clothing adapted for use by a person using the snap fastener system is provided. In a preferred embodiment, the article of clothing is a shirt, which is preferably a button-down shirt. The system is particularly useful for attaching a speaker microphone connected to a two-way radio with a coiled cord.

The snap fastener system comprises two corresponding, interlocking discs, which can quickly and easily be snapped together to securely attach the speaker microphone to the shirt worn by the user. One of the interlocking discs is attached to the back of the speaker microphone, and the other disc is attached to a strap having two ends, with each end being attached to the shirt. In order to attach the speaker microphone to the shirt, the user simply presses the disc on the speaker microphone firmly against the corresponding disc attached to the strap. The corresponding discs will securely lock together such that the speaker microphone will be safely and securely attached to the user's shirt. In different embodiments, the strap may be attached to the shirt in different locations, but should be attached in the general area of the user's neck, shoulders, or upper chest area. Attachment at these locations will allow the user to quickly and easily access the speaker microphone to hold it to his mouth for transmitting a message or to his ear for receiving a message.

Accordingly, one object of the present invention is to provide an article of clothing adapted for quickly and easily securing a speaker microphone or similar communication equipment to the article of clothing. Another object of the present invention is to provide a snap fastening system configured for quickly and easily snapping a speaker microphone to an article of clothing. Furthermore, another object of the present invention is to provide a kit for retrofitting a snap fastening system to an existing article of clothing and/or an existing speaker microphone. These and other objects and advantages will become apparent from the following description.

### DESCRIPTION OF THE DRAWINGS

These and other features, aspects, and advantages of the present invention will become better understood with regard to the following description, appended claims, and accompanying drawing where:

FIG. 1 is a perspective view of a shirt embodying features of the present invention.

FIG. 2 is a front elevational view of a shirt embodying features of the present invention.

FIG. 3 is a perspective view of a strap embodying features of the present invention, said strap having one part of a snap fastener attached thereto.

FIG. 4 is a partial rear elevational view of a two-way radio speaker microphone embodying features of the present invention.

FIG. 5 is a side perspective view of a two-way radio speaker microphone embodying features of the present invention.

FIG. 6 is a front elevational view of a shirt embodying features of the present invention, said shirt having a speaker microphone attached thereto.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In one aspect, the present invention comprises a snap fastener system for securely attaching a piece of communication equipment, such as a two-way radio speaker microphone, to an article of clothing. In another aspect, the present invention comprises an article of clothing adapted for use by a person using the snap fastener system. The system allows a person wearing the article of clothing to quickly, easily, and securely attach a piece of communication equipment to the article of clothing. The system provides a primary means of attachment, and preferably a secondary means of attachment, so that the person can keep the communication equipment attached to his person and ready for immediate use at all times. Thus, the present invention provides not only convenience for workers or other individuals who need to remain in constant communication with co-workers, but also eliminates safety risks that may occur when lines of communication are temporarily broken. The system is particularly useful for attaching a speaker microphone connected to a two-way radio with a coiled cord, which is a common means of communication between workers in various industries, including law enforcement personnel, fire fighters, paramedics, operators working in refineries or chemical plants, workers on oil platforms or at other drilling sites, workers at various types of construction sites, crane operators, and crew members on boats, among other examples.

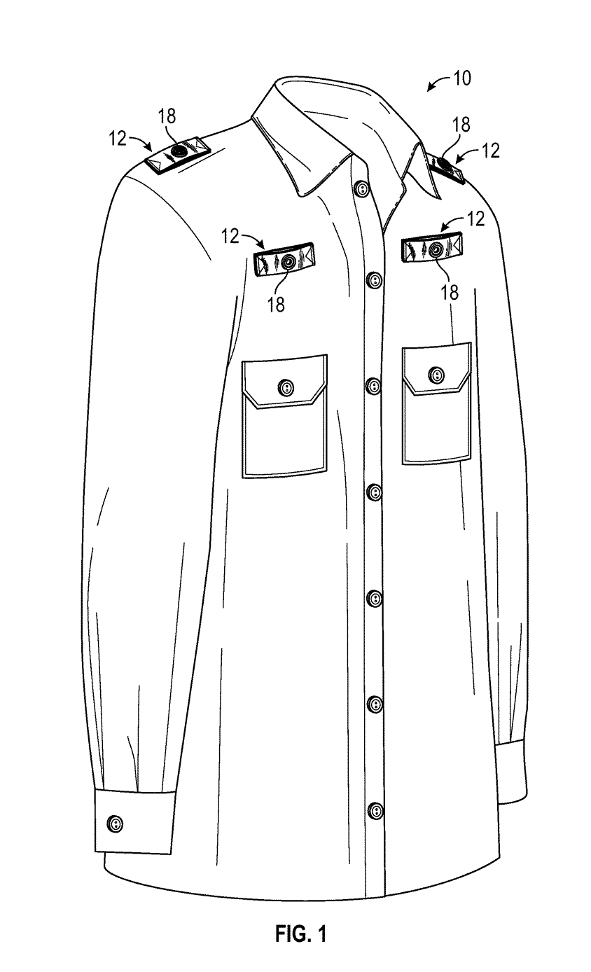

FIGS. 1-6 illustrate preferred embodiments of the present invention. As shown in FIG. 1, the article of clothing is preferably a shirt 10, which is preferably a button-down shirt 10. In an alternative embodiment, the article of clothing may be a jumpsuit, a jacket, or similar type of clothing. In some embodiments, the article of clothing may be fire retardant clothing, which may be necessary in certain work environments, such as in a refinery or chemical plant.

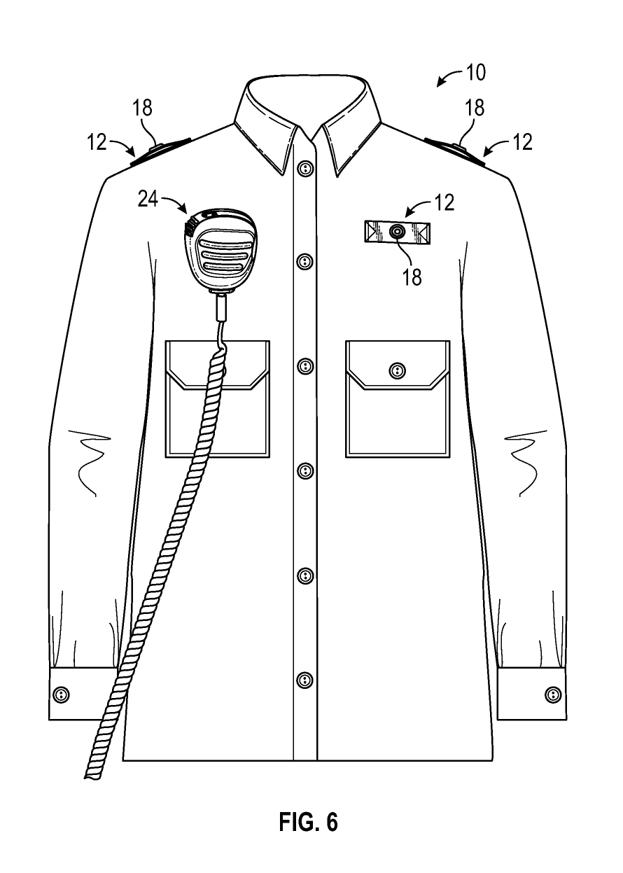

As shown in FIG. 6, the system is preferably used to attach a speaker microphone 24 to the shirt 10. The speaker microphone 24 is typically connected to a two-way radio handset (not shown) by a coiled cord. The handset is commonly clipped or otherwise attached to the user's belt or any other attachment point typically in the area of the user's waist. The speaker microphone 24 is then used for communication. Although the use of a speaker microphone 24 is optional for communication with a two-way radio, it is commonly used because it is smaller and more lightweight than the handset and thus easier to use. However, it should be understood that the snap fastener system of the present invention may be used to attach a handset directly to a shirt 10 without the use of a speaker microphone 24 and still fall within the scope of the present invention. Furthermore, it should be understood that the snap fastener system of the present invention may be used to attach any item to a shirt 10 and still fall within the scope of the present invention.

As used herein, the terms “snap fastener” or “snap fastener system” include any fastening system comprising two interlocking parts that can be securely joined together by pressing (or “snapping”) the two parts together with a predetermined amount of force. The interlocking parts can also be quickly and easily unfastened, typically by pulling the interlocking parts in opposite directions with a similar amount of force. In a preferred embodiment, the interlocking parts are compatible circular male and female parts. However, the snap fastener of the present invention may comprise interlocking parts of any shape that can be quickly and easily fastened by pressing the parts together and unfastened, preferably by pulling the parts apart with a certain amount of force. The amount of force required is generally ordinary thumb pressure, or generally an amount such that the interlocking parts can be fastened and unfastened quickly and easily by a person pressing the parts together using the person's hands and/or fingers without undue exertion. Similar snap fasteners are commercially available and commonly used in a variety of applications. It should be understood that any suitable commercially available snap fastener may be utilized in the manufacturing of the present invention. Suitable commercial snap fasteners may include standard snap fasteners (sometimes referred to as ring snap fasteners), spring snap fasteners, directional snap fasteners (also referred to as locking snap fasteners or one-way-pull snap fasteners), or any similar type of fastener known in the art. The interlocking parts are preferably made of metal, though they may be made of plastic or any similar suitable material.

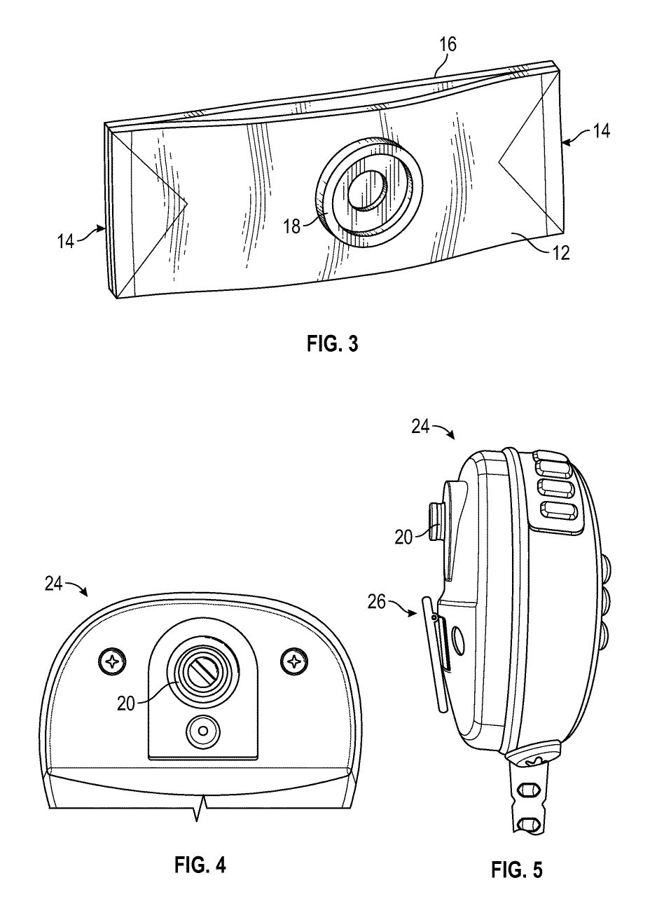

The snap fastener system of the present invention comprises a strap 12 and two interlocking parts. In a preferred embodiment, the interlocking parts are two corresponding, three-dimensional, circular interlocking discs 18, 20. One of the interlocking discs 18, 20 is attached to the strap 12, and the other is attached to the speaker microphone 24, as shown in FIGS. 3-5. The strap 12 is then attached to the shirt 10 such that the two separate interlocking discs 18, 20 can be quickly and easily snapped together to securely attach the speaker microphone 24 to the shirt 10, as shown in FIG. 6.

In a preferred embodiment, as shown in FIG. 3, the snap fastener system further comprises a piece of support material 16. The strap 12 has two ends 14, and each end 14 is attached to the support material 16. The support material 16 is attached directly to the shirt 10, preferably by stitching the support material 16 to the shirt 10, though any suitable means of attaching may be utilized. Thus, by stitching the support material 16 directly to the shirt 10, the support material 16 is integrated with the fabric of the shirt 10, thereby providing a sturdy point of attachment where each end 14 of the strap 12 is attached to the shirt 10. In a preferred embodiment, the support material 16 is stitched to the shirt 10 along the edges of the support material 16 around the entire perimeter of the support material 16. More preferably, additional stitching is then applied across the support material 16 from one end to another. The application of additional stitching provides a strong base for attaching the strap 12 to the shirt 10. In another embodiment, the ends 14 of the strap 12 are stitched or otherwise attached directly to the shirt 10 without support material. However, the use of support material 16 is preferred because it provides a snap fastener system that is sturdier and more durable. The use of support material 16 helps prevent tearing of the shirt 10 in the area of the strap 12 over long periods of time due to the added weight of attaching a speaker microphone 24 or other equipment to the shirt 10.

The strap 12 is preferably made of a flexible and durable material such as cloth or leather, though any suitable material may be used. Preferably, the strap 12 is made of a heavy-duty fabric. The strap 12 and the support material 16 may be made of the same or different materials. For instance, in one preferred embodiment, the support material 16 is made of leather and the strap 12 is made of heavy-duty fabric. In a preferred embodiment, the strap 12 is about 3 inches to about 5 inches long and about ½ inch to about 2 inches wide, though the dimensions of the strap 12 may vary without departing from the spirit of the invention, as long as the strap 12 is of a size suitable for attaching one of the interlocking discs 18, 20 to the strap 12. The support material 16 is preferably about the same size and shape of the strap 12, or slightly larger than the strap 12, though in another embodiment the support material 16 may be significantly larger than the strap 12 and/or a different shape. In this embodiment, the larger size of the support material 16 may provide added strength by covering a larger surface area of the shirt, thereby providing a more durable snap fastener system.

As illustrated in FIGS. 3 and 5, one of the interlocking discs is a female disc 18 and one is a male disc 20. In a preferred embodiment, the male disc 20 comprises a small, circular protuberance having a circular groove extending entirely around the outer surface of the protuberance such that the distal end of the protuberance has a larger diameter than the grooved portion of the protuberance. The female disc 18 comprises a circular opening having a smaller diameter than the remainder of the disc. The edge of the circular opening forms a circular lip that fits into the circular groove around the protuberance of the male disc 20 when the protuberance is inserted through the opening. The opening in the female disc 18 and the protuberance are sized such that a predetermined amount of force must be applied before the distal end of the protuberance passes through the opening, thereby causing the circular lip to snap into place in the groove. When the lip is in the groove, the discs are securely fastened together. The force is applied by pressing the two interlocking discs 18, 20 together until they snap into place. If the user wants to disconnect the discs, a predetermined amount of force is used to pull the discs apart until they separate. Therefore, the user can quickly, easily, and securely attach the speaker microphone 24 to his shirt 10 simply by aligning the interlocking discs 18, 20 and pressing the speaker microphone 24 against the strap 12. Similarly, the user can quickly and easily detach the speaker microphone 24 from his shirt 10 simply by pulling the speaker microphone away from his shirt 10.

As illustrated in FIG. 3, only the ends 14 of the strap 12 are attached to the support material 16 (or directly to the shirt 10, depending on the embodiment). This feature serves two functions. First, it allows the user to place his fingers between the strap 12 and the support material 16 attached to the shirt 10, which allows the user to apply force to the back of the disc 18 attached to the strap 12 when snapping the speaker microphone 24 onto the strap 12. Second, the strap 12 serves as a secondary means of attachment. Speaker microphones 24 typically comprise a clip 26, which is normally used to clip the speaker microphone 24 to a collar or pocket. However, if for some reason the snap fastener system fails, the speaker microphone 24 may be clipped to the strap 12. Alternatively, the user may choose to clip the speaker microphone 24 to the strap 12 as the primary means of attachment and use the snap fastener as the secondary means of attachment. Because the plastic clips 26 on speaker microphones 24 sometimes fail, it is extremely advantageous to have a secondary means of attachment, particularly in work environments where emergency situations may occur and instant communication is critical.

In a preferred embodiment, as shown in FIGS. 3 and 5, the female disc 18 is attached to the strap 12 and the male disc 20 is attached to the back of the speaker microphone 24, though the male and female disc attachment points may be switched without departing from the spirit of the invention. In a preferred embodiment, the female interlocking disc 18 is attached to the strap 12 by forming a hole through the strap 12 and fastening the disc 18 to the strap 12 using a rivet. There are many variations and different styles of rivets that can be used to fasten an individual snap fastener disc to cloth, leather, or any similar flexible material, and any method of riveting known in the art may be used to attach the disc 18 to the strap 12. In a preferred embodiment, the rivet has a wide button that is positioned on the back side of the strap 12, i.e., the side facing the support material 16, so that the user can press on the button when applying force to the snap fasteners for the purpose of attaching the speaker microphone 24 to the shirt 10. Alternatively, the disc 18 may be attached to the strap 12 by sewing the disc 18 to the strap 12, by using specifically designed snap pliers, or by any similar suitable means known in the art.

In a preferred embodiment, the other corresponding interlocking disc 20 is attached to the back of the speaker microphone 24 also using a rivet. In this case, a hole is drilled through the plastic surface of the back of the speaker microphone 24, and a blind rivet is installed using a mandrel. In an alternative embodiment, the disc 20 may be attached to the back of the speaker microphone 24 also using high-strength glue, adhesive, or any similar attachment means known in the art. Although riveting provides the most secure attachment, a glue or adhesive may be preferred in some embodiments because it does not require drilling a hole into an existing speaker microphone 24. In another embodiment, the present invention may comprise a speaker microphone 24 with one interlocking disc 20 of a snap fastener pre-installed during the manufacturing of the speaker microphone 24. This embodiment avoids the problem of a user having to drill a hole in an existing speaker microphone and potentially damaging the internal components of the speaker microphone in order to install the snap fastener. A speaker microphone 24 having a pre-installed snap fastener disc 20 may then be connected to an existing two-way radio.

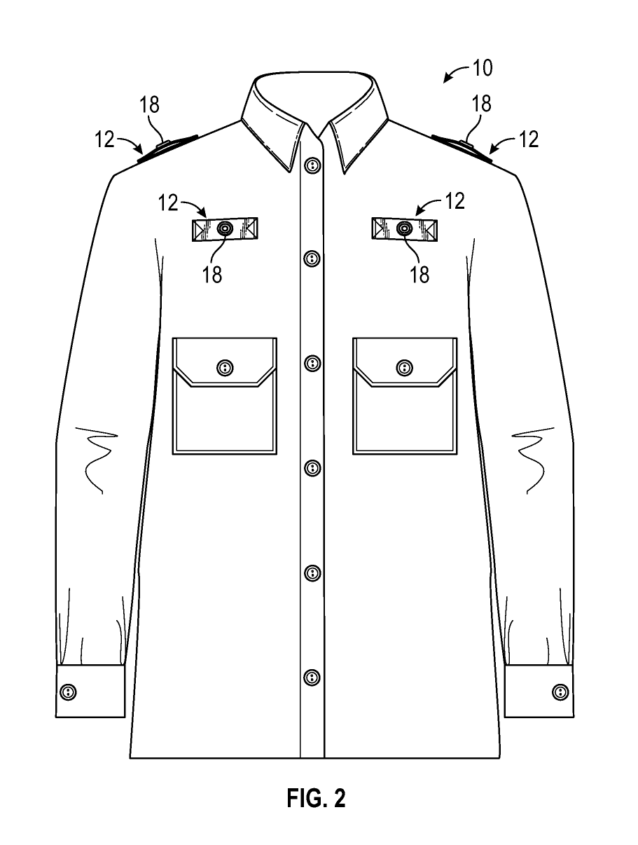

In a preferred embodiment, as shown in FIGS. 1-2, the strap 12 is configured in a generally horizontal position. Though the strap may be positioned vertically in alternative embodiments, the horizontal position is preferred because it is generally easier for the user to clip the speaker microphone 24 to a horizontal strap 12 when using a clip 26 as an alternative means of attachment to the shirt 10.

In a preferred embodiment, as shown in FIGS. 1-2, the strap 12 may be positioned in different areas of the shirt 10. In a preferred embodiment, the strap 12 is positioned generally in the chest area of the shirt 10. The strap 10 may be positioned in the chest area on the left side or the right side of the shirt 10. Alternatively, one strap 12 may be positioned on the left side and another strap 12 on the right side of the chest area. This embodiment provides the user with the option of which side he prefers to attach the speaker microphone 24. In another preferred embodiment, as shown in FIGS. 1-2, the strap 12 is positioned generally in the shoulder area of the shirt 10. Similarly, the strap 10 may be positioned on the right shoulder, on the left shoulder, or a strap 12 may alternatively be positioned on each shoulder. In another alternative embodiment, the shirt 10 may have straps on each side of the chest and on each shoulder, or in any combination of these locations on the shirt 10.

It is understood that versions of the invention may come in different forms and embodiments. Additionally, it is understood that one of skill in the art would appreciate these various forms and embodiments as falling within the scope of the invention as disclosed herein. For instance, the present invention may be sold as a shirt 10 or other article of clothing having one or more straps 12 attached to the shirt 10, as shown in FIG. 1. In one embodiment, the ends 14 of the one or more straps 12 may be attached directly to the shirt 10. In another embodiment, the shirt 10 may comprise a piece of support material 16 integrated with the fabric of the shirt 10, with the support material 16 providing a point of attachment where each end 14 of the strap 12 is attached to the shirt 10. The use of support material 16 is preferred because it provides added strength to help support the weight of attached communications equipment. Additionally, the shirt 10 may be sold with a two-way radio speaker microphone 24 having one part of a snap fastener system pre-installed, as shown in FIGS. 4-5, that is compatible with a corresponding part of the snap fastener system attached to the strap 12 on the shirt 10.

Alternatively, the present invention may comprise a kit for retrofitting a snap fastener system to an existing shirt 10 or other article of clothing and/or an existing speaker microphone 24 or similar communications equipment. For instance, the kit may comprise one or more straps 12 having one part of a snap fastener attached thereto, as illustrated in FIG. 3. Each end 14 of the one or more straps 12 included in the kit may then be stitched or otherwise attached to an existing article of clothing in any desired location on the clothing. Alternatively, the kit may comprise one or more straps 12 with each end 14 of each strap 12 attached to a piece of support material 16, as shown in FIG. 3. Each piece of support material 16 having an attached strap 12 may then be stitched or otherwise attached to an existing article of clothing in any desired location. Alternatively, the kit may comprise an article of clothing with one or more straps 12 pre-installed with or without support material 16. Furthermore, the kit may also comprise a two-way radio speaker microphone 24 having one part of a snap fastener system pre-installed, as shown in FIGS. 4-5, that is compatible with the corresponding part of the snap fastener system attached to the one or more straps 12 included in the kit. Alternatively, the kit may be sold with the one or more straps 12 and the corresponding parts of the snap fastener along with rivets or similar attachment means for attaching the corresponding parts of the snap fastener to an existing speaker microphone 24 as described previously. It should be understood that any of the combinations or embodiments described above would fall within the scope of the present invention.

What is claimed is:

1. An article of clothing adapted for securely attaching an item thereto, said article of clothing comprising:
a. a strap having two ends, each end attached to said article of clothing; and
b. a first interlocking part attached to said strap, said first interlocking part being compatible with a second interlocking part attached to said item such that the two interlocking parts can be securely joined together by pressing the two parts together with a predetermined amount of force.

2. The article of clothing of claim 1, wherein said article of clothing is a shirt, a jacket, or a jumpsuit.

3. The article of clothing of claim 1, wherein the strap is about 3 inches to about 5 inches long and about ½ inch to about 2 inches wide.

4. The article of clothing of claim 4, wherein the strap is configured in a generally horizontal position.

5. The article of clothing of claim 1, wherein the strap is positioned generally in the chest area or the shoulder area of the article of clothing.

6. The article of clothing of claim 1, further comprising a piece of support material integrated with the fabric of said article of clothing, wherein the support material provides a point of attachment for attaching each end of said strap to said article of clothing.

7. The article of clothing of claim 1, wherein the first interlocking part is a female part comprising a circular opening, the edge of said opening forming a circular lip, and the second interlocking part is a male part comprising a circular protuberance having a circular groove extending entirely around the outer surface of the protuberance such that the distal end of the protuberance has a larger diameter than the grooved portion of the protuberance, said male and female parts being compatible such that the lip fits into the groove when the two parts are pressed together with a predetermined amount of force.

8. A fastening system for securely attaching an item to an article of clothing, said fastening system comprising:
a. a strap having two ends, each end attached to said article of clothing; and
b. a snap fastener comprising first and second interlocking parts, said first interlocking part attached to said strap, said second interlocking part attached to said item.

9. The fastening system of claim 8, wherein said article of clothing is a shirt, a jacket, or a jumpsuit.

10. The fastening system of claim 8, wherein the item is a speaker microphone for use with a two-way radio.

11. The fastening system of claim 8, wherein the strap is about 3 inches to about 5 inches long and about ½ inch to about 2 inches wide.

12. The fastening system of claim 8, wherein the strap is configured in a generally horizontal position.

13. The fastening system of claim 8, wherein the strap is positioned generally in the chest area or the shoulder area of the article of clothing.

14. The fastening system of claim 8, further comprising a piece of support material integrated with the fabric of said article of clothing, wherein the support material provides a point of attachment for attaching each end of said strap to said article of clothing.

15. The article of clothing of claim 8, wherein the first interlocking part is a female part comprising a circular opening, the edge of said opening forming a circular lip, and the second interlocking part is a male part comprising a circular protuberance having a circular groove extending entirely around the outer surface of the protuberance such that the distal end of the protuberance has a larger diameter than the grooved portion of the protuberance, said male and female parts being compatible such that the lip fits into the groove when the two parts are pressed together with a predetermined amount of force.

16. A kit for attaching an item to an article of clothing, said kit comprising:
a. a strap having a first interlocking part attached to said strap; and
b. a second interlocking part, wherein the second interlocking part is compatible with the first interlocking part such that the two interlocking parts can be securely joined together by pressing the two parts together with a predetermined amount of force.

17. The kit of claim 16, further comprising a speaker microphone for use with a two-way radio, wherein said second interlocking part is attached to the speaker microphone.

18. The kit of claim 16, further comprising an article of clothing, wherein said strap has two ends, each end attached to the article of clothing.

19. The kit of claim 18, wherein said article of clothing further comprises a piece of support material integrated with the fabric of said article of clothing, wherein the support material provides a point of attachment for attaching each end of said strap to said article of clothing.

20. The kit of claim 16, wherein the strap is about 3 inches to about 5 inches long and about ½ inch to about 2 inches wide.

21. The kit of claim 16, further comprising a piece of support material, wherein said strap has two ends, each end attached to the piece of support material.

22. The kit of claim 16, wherein the first interlocking part is a female part comprising a circular opening, the edge of said opening forming a circular lip, and the second interlocking part is a male part comprising a circular protuberance having a circular groove extending entirely around the outer surface of the protuberance such that the distal end of the protuberance has a larger diameter than the grooved portion of the protuberance, said male and female parts being compatible such that the lip fits into the groove when the two parts are pressed together with a predetermined amount of force.
